(19) United States
(12) Patent Application Publication
(10) Pub. No.: US 2013/0276905 A1
(43) Pub. Date: Oct. 24, 2013

(54) VALVE HOUSING FOR A VACUUM VALVE

(71) Applicant: VAT HOLDING AG, Haag (CH)

(72) Inventors: Anton Neumeir, Mering (DE); Friedrich Geiser, Nuziders (AT); Thomas Blecha, Feldkirch (AT); Bernhard Duelli, Ubersaxen (AT)

(73) Assignee: VAT Holding AG, Haag (CH)

(21) Appl. No.: 13/845,461

(22) Filed: Mar. 18, 2013

(30) Foreign Application Priority Data
Apr. 19, 2012 (AT) A472/2012

(51) Int. Cl. F16K 27/00

(52) U.S. Cl. CPC F16K 27/00
USPC 137/15.01; 137/343

(57) ABSTRACT

A valve housing for a vacuum valve has opposed valve openings (8, 9), which have axes (10, 11) and are surrounded by flanges (6, 7) of the valve housing, these flanges being connected to housing parts (1, 2) of the valve housing. A respective flange (6, 7) has, or is formed on the whole by, a sheet metal part (12, 13) formed in a U-shaped manner, as viewed in a longitudinal center section through the flange (6, 7), parallel to the axis (10, 11) of the valve opening (8, 9), and directed via its open side toward the housing part (1, 2). The U-shaped sheet metal part (12, 13) includes inner and outer branches (14, 15) annularly surrounding the axis (10, 11) of the valve opening (8, 9) and a base crosspiece (16) connecting the inner and the outer branch (14, 15).

### INCORPORATION BY REFERENCE

The following documents are incorporated herein by reference as if fully set forth: Austrian Patent Application No.: A472/2012, filed Apr. 19, 2012.

### BACKGROUND

The present invention relates to a valve housing for a vacuum valve, comprising opposed valve openings, which have axes and are surrounded by flanges of the valve housing, said flanges being connected to housing parts of the valve housing, a respective flange having, or being formed on the whole by, a sheet metal part surrounding the respective valve opening, said sheet metal part being formed in a U-shaped manner, as viewed in a longitudinal center section through the flange, parallel to the axis of the valve opening, and being directed via its open side toward the housing part, and having an inner branch, which surrounds the axis of the valve opening annularly and is welded or soldered circumferentially to the housing part at its end bearing against the housing part, an outer branch, which has a greater distance from the axis of the valve opening than the inner branch, and having a base crosspiece distanced from the housing part, said base crosspiece connecting the inner and the outer branch.

Vacuum valves with valve housings with opposed valve openings, which have axes and are surrounded by flanges of the valve housing, said flanges being connected to housing parts of the valve housing, are known for example from U.S. Pat. No. 7,011,294 B1 and WO 2011/088482 A1. The valve housings have axially symmetrical housing parts made of sheet metal, which are welded together along a line of contact. Each of the housing parts has an opening, in the region of which a flange is connected to the housing part by means of welding. The flanges surround opposed valve openings in the valve housing, the axes of said valve openings lying on a common straight line. The valve housing therefore has a straight-lined passage, which is released in the open state of the vacuum valve.

A respective flange comprises a connecting piece welded onto the respective housing part, a solid flange ring being welded onto said connecting piece at the end remote from the housing part. This flange ring projects outwardly beyond the connecting piece and, in this projecting region, has openings distributed over its circumference, which are formed in the manner of threaded bores for screwing in connection screws. Furthermore, spacers are arranged between the solid flange rings of the opposed flanges and are welded via the two flange rings so that the valve housing can withstand the loads that occur.

Flanges of this type are referred to as ISO-F flanges (also as ISO LFB flanges). These are standardized in ISO Standard 1609:1986 and in DIN 28404 and in Pneurop 6606/1981. ISO-F flanges, which have screw holes, can be connected to other ISO-F flanges of identical nominal width or to ISO-K flanges (also referred to as ISO LF flanges) with the interpositioning of seals arranged on centering rings. An ISO-F flange is connected to an ISO-K flange by means of mushroom head anchor screws or by means of a collar flange, wherein a retaining ring is inserted into the groove running outwardly in the ISO-K flange.

A valve formed from sheet metal is disclosed in DE 29 27 369 A1. The valve comprises two housing halves and a sealing and guiding housing for guiding a barrier plate. The sealing and guiding housing receives, in bead-like convexities, sliding rings and sliding posts as well as seal elements for the barrier plate. The housing halves are interconnected via outer flanges with screws. Outside the flow opening, fastening sleeves are attached in the lateral surface of the housing halves. The housing halves thus form flanges of the valve housing.

The valve known from DE 29 27 369 A1 is not designed for use in a vacuum. In principle, it would be possible to use the valve housing of this valve with the corresponding seals for a vacuum valve. If the housing halves are understood as flanges of the valve housing and the parts of the sealing and guiding housing are understood as housing parts of the valve housing, the valve housing known from DE 29 27 369 A1 can thus be considered as a valve housing of the type mentioned in the introduction. Disadvantages of this vacuum valve are, inter alia, the complex design and the relatively low stability.

ISO-F flanges with solid flange rings are not only used in conjunction with valve housings formed from sheet metal housing parts, but also with solid valve housings.

### SUMMARY

The object of the invention is to provide an advantageous valve housing, which can be produced cost-effectively. This is achieved by a valve housing having one or more of the features of the invention.

With the valve housing according to the invention, the sheet metal part surrounding the respective valve opening, in addition to the inner branch annularly surrounding the axis of the valve opening, also has an outer branch annularly surrounding the axis of the valve opening, said outer branch having a greater distance from the axis of the valve opening compared to the inner branch, and a base crosspiece distanced from the housing part, said base crosspiece connecting the inner and the outer branch. The sheet metal part is therefore formed in a U-shaped manner, as viewed in any longitudinal center section through the flange, parallel to the axis of the valve opening, and is directed via its open side toward the housing part.

The inner and the outer branch of the U-shaped sheet metal part are thus formed in a circumferentially closed manner, that is to say they surround the axis of the valve opening over the entire circumference.

Due to the design according to the invention of the flanges, costs can be saved compared to vacuum valves having solid flanges, wherein sufficient stability can still be achieved. The saving in costs is provided initially by the saving of a solid flange ring. Furthermore, due to the design according to the invention, the number of parts to be manufactured can be reduced. In addition, the production of the U-shaped sheet metal part can be automated.

A curvature, which preferably runs over 90°, is located between the base crosspiece and the respective branch of the respective U-shaped sheet metal part, that is to say the base crosspiece and the respective branch are arranged at right angles to one another. Deviations from an angle of 90° are also conceivable and possible, in particular in the range from +/−30°. Such a sheet metal part can still be referred to as U-shaped.

The radius of curvature via which the base crosspiece is connected to the respective branch is preferably less than twice the value of the thickness of the sheet metal part, more preferably less than 1.5 times the value of the thickness of the sheet metal part.

The thickness of the sheet metal part is preferably less than 5 mm, more preferably 3 mm or less. In order to achieve sufficient stability with minimal thickness of the sheet metal, the sheet metal thickness is conveniently adapted to the nominal width of the flange so that a greater thickness of the sheet metal is provided with greater nominal widths of the flange than with smaller nominal widths.

The axes of the valve openings in particular lie on a common straight line, wherein the valve openings preferably have the same shape and size.

In order to connect the respective flange to a flange of another vacuum unit (with interpositioning of a seal), the base crosspiece conveniently has screw openings for connection screws. In a possible variant, an annular extension into which a thread is cut can be formed during the production of a respective screw opening, in particular with the aid of a burin, by means of plastic deformation of the base crosspiece. The connection screw can then be screwed into the threaded hole thus formed. In this case, a respective flange can be formed on the whole by the sheet metal part. In another variant, nuts can be fastened to the base crosspiece. For example, nuts can be welded or soldered onto the base crosspiece on the side of the base crosspiece facing the housing part. Nuts may also be fastened to the base crosspiece in another way, for example by beading or by pressing into the screw opening in the base crosspiece, wherein the nut is set back from the side of the base crosspiece remote from the housing part or is flush therewith. The connection screws can then be screwed into the nuts through the screw openings in the base crosspiece.

In accordance with an advantageous embodiment of the invention, the surface of the respective U-shaped sheet metal part pointing toward the axis of the valve opening, said surface delimiting the valve opening, is provided in an end region remote from the housing part with a recess running around the valve opening. The base of this recess forms a contact face for a centering ring, which carries an elastomer ring seal, in order to center the centering ring inserted into the flange. This contact face runs cylindrically about the axis of the valve opening.

As a result of the design according to the invention, a valve housing with flanges according to the ISO-F Standard can be provided for example. Flanges according to other standards, for example ASA-LP, can also be provided in accordance with the invention.

The housing parts to which the U-shaped sheet metal parts are fastened can advantageously be formed from a worked sheet metal. A valve housing that can be formed easily on the whole and is particularly cost-effective can thus be provided.

The U-shaped sheet metal parts for forming the flange can advantageously be formed from a flat sheet metal by means of a deep drawing method. For sufficiently precise formation with a minimal radius of curvature between the respective branch and the base crosspiece, the deep drawing process is conveniently followed by a further pressing process.

Such a further pressing of deep drawn parts is used for example in the automotive industry to form vehicle body parts.

The recess on the surface of the U-shaped sheet metal part pointing toward the axis of the valve opening is conveniently produced by a machining step, for example using a turning tool or a milling tool, in order to form a contact face for a centering ring.

If, in this step, the specifications “inner” and “outer” are used in conjunction with the flanges, this is thus based on the position in relation to the axes of the valve openings. A part arranged further inwardly is thus arranged closer to the axis of the respective valve opening than a part arranged further outwardly.

### BRIEF DESCRIPTION OF THE DRAWINGS

Further advantages and details of the invention will be explained hereinafter on the basis of the accompanying drawing, in which:

FIG. 1 shows a view of a valve housing according to the invention;

FIG. 2 shows a section along the line AA from FIG. 1;

FIG. 3 shows an exploded illustration of the valve housing from FIG. 1;

FIG. 4 shows a view of the valve housing from FIG. 1 with an inserted centering ring with ring seal and outer ring;

FIG. 5 shows a side view of the parts illustrated in FIG. 4;

FIG. 6 shows a section along the line BB from FIG. 4, wherein a part of a vacuum unit connected to the valve housing is additionally schematically illustrated;

FIG. 7 shows an enlarged detail C from FIG. 6;

FIG. 8 shows a view of a vacuum valve with a valve housing according to the invention in the open state of the vacuum valve;

FIG. 9 shows a section along the line DD from FIG. 8; and

FIG. 10 shows a section, corresponding to FIG. 9, in the closed state of the vacuum valve.

### DETAILED DESCRIPTION OF THE PREFERRED EMBODIMENTS

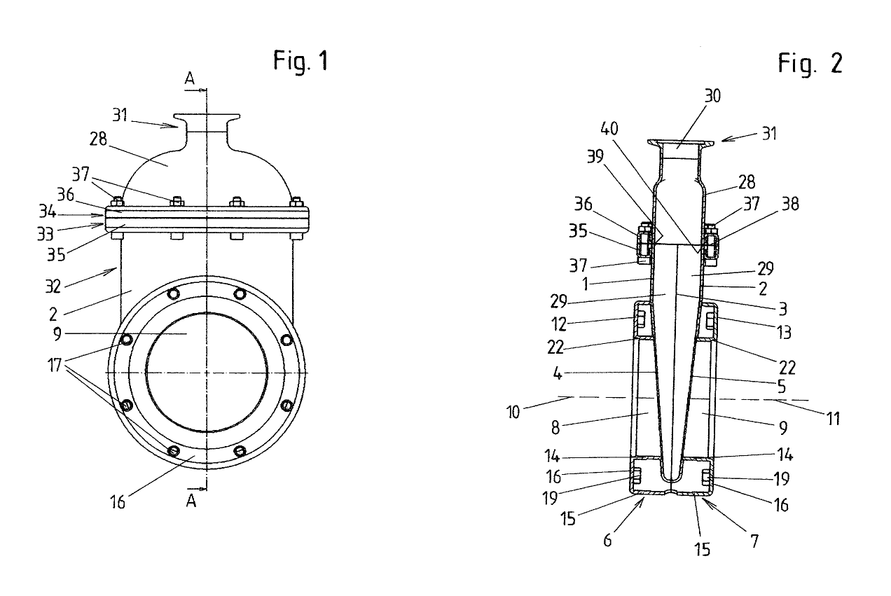

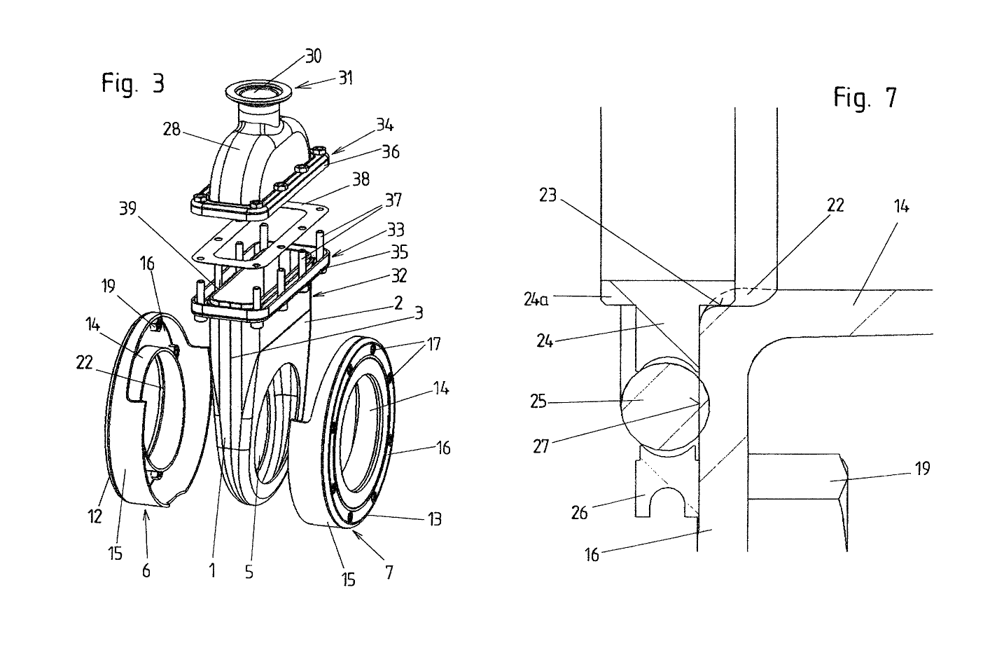

The exemplary embodiment for a valve housing according to the invention illustrated in FIGS. 1 to 3 has a main part 32, which consists of two axially symmetrical housing parts 1, 2 made of sheet metal. The housing parts 1, 2 are welded or soldered together along a line of contact 3, at which the narrow sides of the sheet metals, from which the housing parts 1, 2 are formed, butt against one another. The line of contact 3 lies on, a center plane. The housing parts 1, 2 each have an opening 4, 5, wherein the openings 4, 5 are circular in the exemplary embodiment and have the same size and align with one another in the direction at right angles to the center plane. The openings 4, 5 may also have different sizes, wherein they are preferably coaxial.

The valve housing has opposed flanges 6, 7, which surround opposed valve openings 8, 9, via which the valve housing is open toward the surrounding outer space. The valve openings have axes (=longitudinal axes) 10, 11, which lie on a common straight line and are arranged at right angles to the center plane of the valve housing.

A respective flange 6, 7 has a sheet metal part 12, 13, which is formed by worked sheet metal and is U-shaped, as viewed in the longitudinal center section through the flange, parallel to the axis 10, 11 of the valve opening 8, 9 (see FIG. 2). The respective sheet metal part 12, 13 has an inner branch 14, which annularly surrounds the axis 10, 11 of the respective valve opening 8, 9, in the exemplary embodiment circularly, and is welded or soldered circumferentially over its entire circumference to the respective housing part 1, 2 at its end bearing against the housing part 1, 2. In this case, this end bears against the edge of the opening 4, 5 of the respective housing part 1, 2. At its other end remote from the housing part 1, 2, the inner branch 14 is connected to a base crosspiece 16 of the sheet metal part 12, 13 via a curvature of the sheet metal part 12, 13 running over 90°, said base crosspiece connecting the inner branch 14 to an outer branch 15 of the sheet metal part 12, 13 via a curvature of the sheet metal part running over 90°. The outer branch 15 annularly surrounds the axis 10, 11 of the respective valve opening 8, 9, in the exemplary embodiment circularly, at a greater distance from the axis than the inner branch 14. The base crosspiece 16 likewise runs annularly, in the exemplary embodiment circularly, with the main plane of the base crosspiece lying in the plane of the ring formed thereby. The base crosspiece is distanced from the respective housing part 1, 2. The open side of the respective U-shaped sheet metal part 12, 13 is thus directed toward the respective housing part 1, 2.

The inner and the outer branch 14, 15 and also the base crosspiece 16 each run in a straight line in the longitudinal center section parallel to the axis 10, 11 of the valve opening 8, 9. The base crosspiece 16 in this case is arranged at right angles to the axis of the valve opening 8, 9. The inner and outer branch 14, 15 of the respective sheet metal part 12, 13 are arranged parallel to the axis 10, 11 of the valve opening 8, 9.

The sheet metal parts 12, 13 are preferably axially symmetrical, as illustrated.

The outer branch 15 of the respective sheet metal part 12, 13 is connected at least over part of its circumference to the respective housing part 1, 2 at its end face bearing against the respective housing part 1, 2 in this circumferential region, for example via at least one continuous weld seam over part of the circumference, or via spot welds, or by soldering.

The sheet metal parts 12, 13 extend over part of their circumference radially outwardly beyond the housing parts 1, 2, as viewed in the direction of the axes 10, 11 of the valve openings 8, 9 of the valve housing (see FIG. 1). The outer branches 15 have a greater length, at least over a partial region of this part of the circumference of the respective sheet metal part 12, 13, and extend via said length laterally beside the respective housing part 1, 2. In this case, the end faces of the outer branches 15 remote from the base crosspiece 16 butt against one another and are directly interconnected, for example via spot welds, or via at least one continuous weld seam over part of the circumference, or by soldering.

The annular base crosspiece 16 of the respective sheet metal part 12, 13 has screw openings 17 distributed uniformly over its circumference for the passage of connection screws 18 (see FIG. 6). Nuts 19 are welded onto the side of the base crosspiece 16 facing the respective housing part 1, 2 and thus lie in the space between the branches 14, 15. The connection screws 18 are screwed into these nuts 19. The connection screws 18 are used to connect the respective flange 6, 7 of the valve housing to a flange 20 of another vacuum unit, of which, apart from the flange 20, only a small part of a wall 21 is shown in FIG. 6. In this case, the other vacuum unit may be a vacuum chamber in particular. For example, this other vacuum unit could also be a vacuum pump, a connecting piece, or a tube.

In the exemplary embodiment, a respective flange 6, 7 is thus formed by the respective sheet metal part 12, 13 together with the nuts 19 welded onto the base crosspiece 16. In a variant, the screw openings 17 could be provided directly with a thread. If the wall thickness of the sheet metal is insufficient for this purpose, the sheet metal could be bent back inwardly circumferentially around the screw openings 17, in such a way that it forms the shape of a short connecting piece, on the inner wall of which the thread for the connection screw 18 is formed. The respective flange 6, 7 could then be formed merely by the respective sheet metal part 12, 13, that is to say in one piece.

The surface of the respective U-shaped sheet metal part 12, 13 pointing toward the axis 10, 11 of the respective valve opening 8, 9 is provided in an end region remote from the respective housing part 1, 2 with a recess 22, which runs around the valve opening 8 and has a base. Part of the surface of the base forms a contact face 23, which is flat, as viewed in the longitudinal center section (see in particular the enlarged illustration of FIG. 7), and cylindrically surrounds the axis 10, 11 of the respective valve opening 8, 9. Due to the recess 22, part of the curvature connecting the inner branch 14 to the base crosspiece 16 is reduced (on its side remote from the gap arranged between the branches 14, 15).

The recess 22 with the contact face 23 is used for insertion of a centering ring 24, which carries a ring seal 25 made of an elastomer material, see FIG. 7 (in which the ring seal 25 is illustrated in its relaxed state, as is conventional in such illustrations). Outwardly, the ring seal is surrounded by an outer ring 26, which is held on the ring seal 25 and is used for support between the flanges to be connected. Such an outer ring 26 may optionally also be omitted.

The centering ring 24 has, attached to its central opening, protrusions 24a protruding on either side. The protrusion 24a protruding on one side is inserted into the recess 22 and bears against the contact face 23.

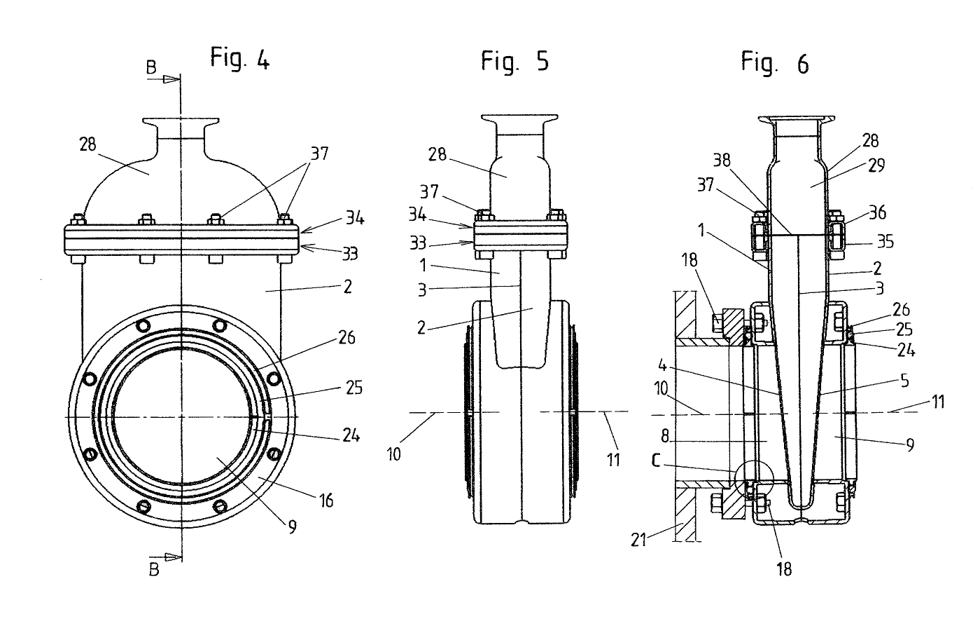

The contact face 23 formed by the base of the recess 22 centers the centering ring 24 in the respective flange 6, 7 (see FIGS. 4 to 7). The radius of curvature of the curvature connecting the base crosspiece 16 to the inner branch 14, said radius of curvature being provided during the working of the sheet metal to form the U-shaped sheet metal part 12, 13, cannot be produced in any size as desired, but has a minimum size. To form the respective U-shaped sheet metal part 12, 13, a flat sheet metal is advantageously deep drawn. A further pressing process conveniently follows the deep drawing process so as to achieve a minimal radius of curvature and improve the dimensional accuracy of the sheet metal part 12, 13. The recess 22 is then drilled out.

Due to the formation of the recess 22, a cylindrical contact face for the centering ring 24 is ensured on the one hand, in spite of the radius of curvature produced during the working of the sheet metal, and therefore the centering ring does not bear against the terminating radius of the curvature. Furthermore, a sufficient spacing of the contact region of the ring seal 25 from the curved region of the sheet metal part 12, 13 can thus be achieved, and therefore the ring seal 25 bears against a cylindrical face of the sheet metal part 12, 13 and not against the sheet metal part 12, 13 in the region of the terminating curvature. This cylindrical surface, which thus forms a sealing face 27 for the ring seal 25, is formed by the surface of the base crosspiece 16 of the respective sheet metal part 12, 13 remote from the respective housing part 1, 2.

The flanges 6, 7 are formed in accordance with the ISO-F Standard or are at least compatible with flanges, centering rings and ring seals, and, if used, outer rings, formed in accordance with the ISO-F Standard.

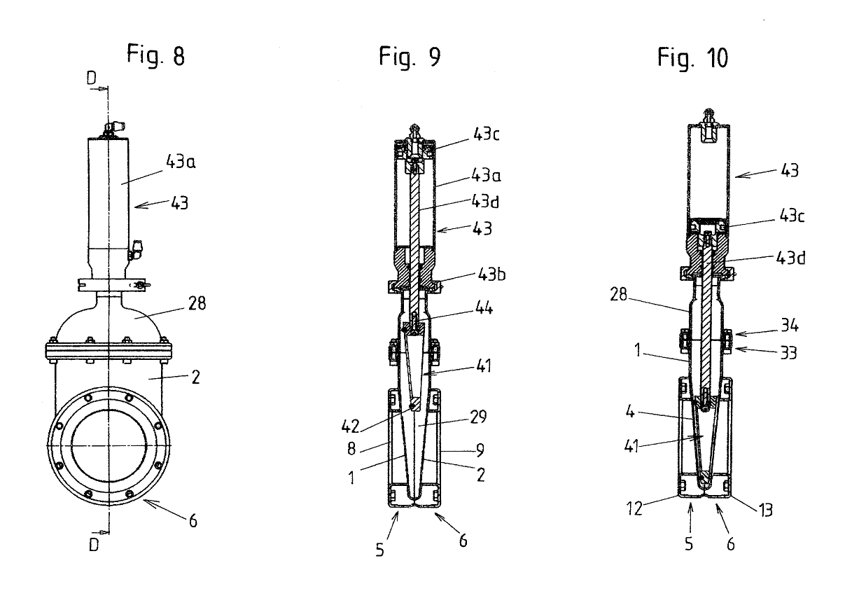

In the exemplary embodiment, the housing parts 1, 2 welded together, which form a main part of the valve housing, are connected to an extension part 28 of the valve housing, by means of which the interior 29 of the valve housing is extended. The extension part has an attachment opening 30 with an attachment flange 31, which is formed in the exemplary embodiment in accordance with the ISO-KF Standard. A drive part of the valve drive can be connected to this attachment flange 31, as will be explained further below with reference to FIGS. 8 to 10.

For connection of the extension part 28 to the main part 32, connection flanges 33, 34 of the main part 32 and of the extension part 28 are used. In the exemplary embodiment, flange rings 35, 36 are welded onto the main part 32 and to the extension part 28 for this purpose, surround the main part 32 and the extension part 28, and have openings for the passage of connection screws 37. The flange rings 35, 36 are formed from sheet metal and are U-shaped in cross section, wherein their open sides are directed toward one another. A use of solid flange rings is also conceivable and possible.

In the exemplary embodiment, flat sheet metal is deep drawn for the production of the extension part 28. The attachment flange 31 and the connection flange 34 are welded or soldered onto said sheet metal.

An annular seal 38 is used for sealing between the main part 32 and the extension part 28. The seal 38 in the exemplary embodiment has the shape of a rectangle with rounded corners. The seal 38 is designed as a flat seal, that is to say it consists of a sheet-like material, of which the main plane lies in the plane of the ring formed by the seal 38.

The seal 38 is arranged between sealing faces 39, 40 of the main part 32 and extension part 28. The sealing face 39 of the main part 32 is formed by the narrow-side edges (=end faces) of the sheet metal pieces forming the housing parts 1, 2. The sealing face 40 of the extension part 28 is formed by the narrow-side edge of the sheet metal forming the extension part 28.

For centering of the seal 38, said seal preferably has openings 38a as illustrated, which are penetrated by the connection screws 37.

FIGS. 8 to 10 show a possible exemplary embodiment of a vacuum valve, which comprises the described valve housing. A closure member 41 is arranged in the interior 29 and carries an annular seal 42. This forms the dynamic seal of the vacuum valve. In the closed state, the seal 42 is pressed against an inner surface of the housing part 1 surrounding the opening 4, said surface forming a sealing face for the seal 42 and thus constituting the valve seat. On the opposite side, the closure member 41 is supported against the housing part 2. To this end, supporting and sliding parts (not illustrated in the figures) can be integrated into the closure member 41, which is wedge-shaped in this exemplary embodiment. The closure member, which is merely illustrated in a simplified manner in FIGS. 9 and 10, can be formed in accordance with the prior art, for example as described in U.S. Pat. No. 7,011,294 B2, as cited in the introduction of the description.

To open the vacuum valve, the closure member 41 is displaced at right angles to the axes 10, 11 of the valve openings 8, 9, and therefore releases the valve openings, whereby a straight-lined passage through the valve is created, see FIG. 9.

To open and close the vacuum valve, a valve drive 43 is used, which, in the exemplary embodiment, is formed by a piston/cylinder unit. The cylinder of this piston/cylinder unit, which constitutes the valve drive part 43a, is equipped with a flange 43b, for example a flange according to the ISO-KF Standard, and can be connected via this flange 43b to the attachment flange 31 of the valve housing. A piston rod 43d, which is moved out of the cylinder and to which the closure member 41 is fastened, for example via a fastening screw 44, is attached to the piston 43c arranged in the cylinder.

Closure members 41 formed otherwise can also be received by a valve housing according to the invention, for example closure members having parts that can be spread apart from one another. Such a closure member is disclosed for example in WO 2011/088482, as cited in the introduction of the description.

A vacuum valve according to the invention can also be designed for use of closure members 41 that are not wedge-shaped in cross section. The housing parts 1, 2 are then modified accordingly.

Depending on the design of the vacuum valve for which the valve housing is used, the housing parts 1, 2 may also run parallel to one another in the region of the openings 4, 5 instead of the illustrated design running toward one another in a wedge-shaped manner. The inner and outer branch 14, 15 are adapted accordingly. They may then have the same length over their entire extension, via which they butt against the respective housing part 1, 2 (=size of their extension in the direction pointing away from the base crosspiece 16).

The extension part 28 could also be omitted and a valve drive part 43a could be attached directly to the connection flange 33. The connection flange 33 could be formed in this case as described before or in a modified form.

In order to provide a sufficient size of the interior 29, the housing parts 1, 2 could be extended in the direction of the movement of the closure member 41.

The valve housing could also comprise additional or other housing parts.

Instead of closure members displaceable in a straight line over their entire path between the open state and the closed state of the vacuum valve, closure members moved in an L-shaped manner could also be used for example.

### KEY TO THE REFERENCE NUMERALS

1 housing part
2 housing part
3 line of contact
4 opening
5 opening
6 flange
7 flange
8 valve opening
9 valve opening
10 axis
11 axis
12 sheet metal part
13 sheet metal part
14 inner branch
15 outer branch
16 base crosspiece
17 screw opening
18 connection screw
19 nut
20 flange
21 wall
22 recess
23 stop face
24 centering ring
24a protrusion
25 seal
26 outer ring
27 sealing face
28 extension part
29 interior
30 attachment opening
31 attachment flange
32 main part
33 connection flange
34 connection flange
35 flange ring
36 flange ring
37 connection screw
38 seal
38a opening
39 sealing face
40 sealing face
41 closure member
42 seal
43 valve drive
43a valve drive part
43b flange
43c piston
43d piston rod
44 fastening screw

1. A valve housing for a vacuum valve, comprising opposed valve openings (8, 9), which have axes (10, 11) and are surrounded by flanges (6, 7) of the valve housing, said flanges being connected to housing parts (1, 2) of the valve housing, each respective one of the flanges (6, 7) having, or being formed by, a sheet metal part (12, 13) that surrounds a respective one of the valve openings (8, 9), each of the sheet metal parts being formed U-shaped, as viewed in a longitudinal center section through the flange (6, 7), parallel to the axis (10, 11) of the valve opening (8, 9), and being directed via an open side thereof toward a respective one of the housing parts (1, 2), and having an inner branch (14), which annularly surrounds the axis (10, 11) of the valve opening (8, 9) and is welded or soldered circumferentially to the respective one of the housing parts (1, 2) at an end thereof bearing against the housing part (1, 2), an outer branch (15), which has a greater distance from the axis (10, 11) of the valve opening (8, 9) than the inner branch (14), and having a base crosspiece (16) distanced from the respective one of the housing parts (1, 2), said base crosspiece connecting the inner and the outer branch (14, 15), and the outer branch (15) annularly surrounds the axis (10, 11) of the valve opening (8, 9).

2. The valve housing according to claim 1, wherein the base crosspiece (16) annularly surrounds the axis (10, 11) of the valve opening, a main plane of said base crosspiece lying in a plane of a ring formed thereby.

3. The valve housing according to claim 2, wherein the inner and outer branch (14, 15) are aligned parallel to the axis (10, 11) of the valve opening (8, 9), and the base crosspiece (16) is arranged at right angles to the axis (10, 11) of the valve opening (8, 9).

4. The valve housing according to claim 2, wherein the base crosspiece (16) has screw openings (17) for connection screws (18) in order to connect the flange (6, 7) to a flange (20) of another vacuum unit.

5. The valve housing according to claim 4, wherein the screw openings (17) are provided with threads, or nuts (19) are fastened to the base crosspiece (16).

6. The valve housing according to claim 2, wherein the outer branch (15) of each of the respective sheet metal parts (12, 13) is connected at least over part of a circumference thereof to the respective housing part (1, 2) at an end face that bears against the respective housing part (1, 2) in this part of the circumference of the outer branch.

7. The valve housing according to claim 1, wherein, in a view of the valve housing in the direction of the axis (10, 11) of one of the valve openings (8, 9), the U-shaped sheet metal parts (12, 13) protrude over part of a circumference thereof radially outwardly beyond the housing parts (1, 2), the outer branch (15) of the sheet metal parts (12, 13) of the two flanges (6, 7) butting against one another and being interconnected at least in a partial region of the part of the circumference of the U-shaped sheet metal parts (12, 13).

8. The valve housing according to one claim 1, wherein a surface of each of the U-shaped sheet metal parts (12, 13) delimiting the valve openings (8, 9) and pointing toward the axis (10, 11) of the valve opening (8, 9) is provided in an end region remote from the housing part (1, 2) with a recess (22) running around the valve opening (8, 9), said recess having a base, which forms a contact face (23) for a centering ring (24), which carries a ring seal (25).

9. The valve housing according to claim 1, wherein the flanges (6, 7) are formed as ISO-F flanges or are at least compatible with said ISO-F flanges.

10. The valve housing according to claim 1, wherein the housing parts (1, 2), to which the flanges (6, 7) are connected, are formed from sheet metal and are welded or soldered along a line of contact (3).

11. The valve housing according to claim 10, wherein the interconnected housing parts (1, 2) form a main part (32) of the valve housing, said main part being connected to an extension part (28) of the valve housing, to which a valve drive part (43a) is connectable, a seal (38) being inserted between sealing faces (39, 40) of the main part (32) and of the extension part (28).

12. The valve housing according to claim 11, wherein the sealing faces (39) of the main part (32) are formed by narrow-side edges of the sheet metal parts forming the main part (32).

13. The valve housing according to claim 11, wherein the extension part (28) is formed from sheet metal and the sealing face (39) of the extension part (28) is formed by a narrow-side edge of the sheet metal forming the extension part.

14. A method for producing a valve housing according to claim 1, comprising deep drawing a flat part made of sheet metal to form each of the U-shaped sheet metal parts (12, 13) of a respective flange.

15. The method according to claim 14, wherein a surface of the U-shaped sheet metal part (12, 13) delimiting the valve opening (8, 9) and pointing toward the axis (10, 11) of the valve opening (8, 9) is machined in a machining step in an end region remote from the housing part (1, 2) for forming a recess running around the valve opening (8, 9), said recess having a base, which forms a contact face (23) for a centering ring (24), which carries a ring seal (25).
